(19) United States
(12) Patent Application Publication
(10) Pub. No.: US 2021/0107656 A1
(43) Pub. Date: Apr. 15, 2021

(54) SEATING SYSTEMS AND METHODS FOR AN INTERNAL CABIN OF AN AIRCRAFT

(71) Applicant: THE BOEING COMPANY, CHICAGO, IL (US)

(72) Inventors: Cynthia A. Vandewall, Snohomish, WA (US); Blake Lane, Cincinnati, OH (US); Craig M. Vogel, Cincinnati, OH (US); Alexander Vago, Cincinnati, OH (US); Alejandro Lozano Robledo, Cincinnati, OH (US)

(73) Assignee: THE BOEING COMPANY, CHICAGO, IL (US)

(21) Appl. No.: 16/600,662

(22) Filed: Oct. 14, 2019

(51) Int. Cl. B64D 11/06

(52) U.S. Cl. CPC B64D 11/0605; B64D 11/0601; B64D 11/0624; B64D 11/0636; B64D 11/0639; B64D 11/0638

(57) ABSTRACT

A seating system for an internal cabin of an aircraft includes a table having at least one panel that is configured to be moved between a stowed position and a deployed position, and at least one seat assembly proximate to the table. The seat assembly is configured to be moved between a forward orientation in which the seat assembly faces away from the table, and a lateral orientation in which the seat assembly faces towards the table.

### FIELD OF EMBODIMENTS OF THE DISCLOSURE

Embodiments of the present disclosure generally relate to seating systems and methods, and more particularly, to reconfigurable seating systems and methods for an internal cabin of a vehicle, such as a commercial aircraft.

### BACKGROUND OF THE DISCLOSURE

Commercial aircraft typically include an internal cabin that may be divided into numerous sections. A cockpit is generally separated from a passenger cabin, which may include a first class section, a business class section, an economy section, and the like.

Seats within an internal cabin of an aircraft are arranged in rows. For example, a row within an internal cabin may include a first set of two or three seats between a sidewall having windows and a first aisle, a middle section of three seats between the first aisle and a second aisle, and a second set of two or three seats between the second aisle and an opposite sidewall having windows. The seats are typically fixed in position. For example, the seats are fixed in a forward-facing position, such that seated passengers face forward.

In general, seating arrangements and amenities within an internal cabin may not cater to preferences of certain passengers. For example, passengers may prefer to socialize with others within an internal cabin, work on matters, or the like, but are typically limited in such endeavors due to the fixed seating arrangement.

With respect to working during a flight, a passenger seated within an internal cabin may utilize a tray table secured to a seat assembly in front of the passenger. Available work space for the passenger is typically limited to the tray table. For example, if the passenger desires to work, the passenger may move the tray table into a deployed position. However, the tray table may not provide a desired amount of work area for certain passengers.

### SUMMARY OF THE DISCLOSURE

A need exists for a reconfigurable seating system and method within an internal cabin of a vehicle. Further, a need exists for a seating system and method within an internal cabin that provides increased work space, amenities, and adaptability for passengers.

With those needs in mind, certain embodiments of the present disclosure provide a seating system for an internal cabin of an aircraft. The seating system includes a table having at least one panel that is configured to be moved between a stowed position and a deployed position, and at least one seat assembly proximate to the table. The seat assembly is configured to be moved between a forward orientation in which the seat assembly faces away from the table, and a lateral orientation in which the seat assembly faces towards the table. In at least one embodiment, the seat assembly is configured to be secured to seat tracks within the internal cabin.

In at least one embodiment, a first pair of seat assemblies is proximate to a first side of the table and a second pair of seat assemblies is proximate to a second side of the table. The second side is opposite from the first side.

As an example, the table includes a central support member. The panel(s) is moveably coupled to the central support member. For example, two panels are moveably coupled to the central support member. The panel(s) is configured to be outwardly and laterally deployed to provide a work surface. As an example, the panel(s) extends along an entire length of the central support member. As another example, the panel(s) extends along a front portion of the central support member.

In at least one embodiment, the table includes at least one user interface extending upwardly from a top surface. The user interface(s) may include a display and/or a device charger.

In at least one embodiment, the seating system includes a first column of a plurality of seat assemblies and a second column of a plurality of seat assemblies. The table is between the first column and the second column.

In an embodiment, a central adaptable seat table assembly is coupled to the seat assembly. The central adaptable seat assembly includes the table. For example, the central adaptable seat table assembly includes a backrest that is configured to be moved between an upright position providing the table in the stowed position, and a downwardly-folded position providing the table in the deployed position.

In at least one embodiment, the seating system is configured to be disposed along a central plane of the internal cabin underneath a stowage bin assembly. In at least one other embodiment, the seating system is configured to be disposed along a sidewall of the internal cabin. The table may be configured to extend from the sidewall.

In at least one embodiment, the table includes a pocket defining a storage chamber.

Certain embodiments of the present disclosure provide a seating method for an internal cabin of an aircraft. The seating method includes arranging a table and at least one seat assembly of a seating system within the internal cabin of the aircraft in a first configuration during a first phase of a flight of the aircraft, and reconfiguring the table and the seat assembly of the seating system within the internal cabin of the aircraft into a second configuration during a second phase of the flight of the aircraft.

In at least one embodiment, said arranging includes moving at least one panel of a table into a stowed position, moving the seat assembly into a forward orientation in which the seat assembly faces away from the table. In at least one embodiment, said reconfiguring includes moving the panel of the table into a deployed position, and moving the seat assembly into a lateral orientation in which the seat assembly faces towards the table.

Certain embodiments of the present disclosure provide an aircraft including an internal cabin, and a seating system within the internal cabin, as described herein.

### BRIEF DESCRIPTION OF THE DRAWINGS

FIG. 1 illustrates a perspective front view of an aircraft, according to an embodiment of the present disclosure.

FIG. 2A illustrates a top plan view of an internal cabin of an aircraft, according to an embodiment of the present disclosure.

FIG. 2B illustrates a top plan view of an internal cabin of an aircraft, according to an embodiment of the present disclosure.

FIG. 3 illustrates a perspective interior view of an internal cabin of an aircraft, according to an embodiment of the present disclosure.

FIG. 4 illustrates a side view of a seat assembly, according to an embodiment of the present disclosure.

FIG. 5 illustrates a top plan view of a section within an internal cabin of an aircraft, according to an embodiment of the present disclosure.

FIG. 6 illustrates a perspective view of the section within the internal cabin of the aircraft.

FIG. 7 illustrates a perspective top view of seating systems within an internal cabin, according to an embodiment of the present disclosure.

FIG. 8 illustrates a perspective top view of a table having panels in deployed positions, according to an embodiment of the present disclosure.

FIG. 9 illustrates a top view of the table having the panels in deployed positions.

FIG. 10 illustrates a lateral view of the table having the panels in deployed positions.

FIG. 11 illustrates an end view of the table having the panels in deployed positions.

FIG. 12 illustrates a perspective top view of the table having the panels in stowed positions.

FIG. 13 illustrates a top view of the table having the panels in stowed positions.

FIG. 14 illustrates a lateral view of the table having the panels in stowed positions.

FIG. 15 illustrates an end view of the table having the panels in stowed positions.

FIG. 16 illustrates a top view of a seating system in a first configuration, according to an embodiment of the present disclosure.

FIG. 17 illustrates a top view of the seating system in a second configuration, according to an embodiment of the present disclosure.

FIG. 18 illustrates a top view of the seating system in a third configuration, according to an embodiment of the present disclosure.

FIG. 19 illustrates a top plan view of a section within an internal cabin of an aircraft, according to an embodiment of the present disclosure.

FIG. 20 illustrates a top view of seating systems within an internal cabin, according to an embodiment of the present disclosure.

FIG. 21 illustrates a perspective view of a seating system within an internal cabin, according to an embodiment of the present disclosure.

FIG. 22 illustrates a perspective view of a seating system within an internal cabin, according to an embodiment of the present disclosure.

FIG. 23 illustrates a perspective front view of a seating system in a first configuration, according to an embodiment of the present disclosure.

FIG. 24 illustrates a perspective front view of the seating system in a second configuration, according to an embodiment of the present disclosure.

FIG. 25 illustrates a perspective view of a seating system within an internal cabin, according to an embodiment of the present disclosure.

FIG. 26 illustrates a perspective view of a seating system within an internal cabin, according to an embodiment of the present disclosure.

FIG. 27 illustrates a perspective view of a table of the seating system, according to an embodiment of the present disclosure.

FIG. 28 illustrates a front view of a user interface, according to an embodiment of the present disclosure.

FIG. 29 illustrates a flow chart of a seating method within an internal cabin of an aircraft, according to an embodiment of the present disclosure.

### DETAILED DESCRIPTION OF THE DISCLOSURE

The foregoing summary, as well as the following detailed description of certain embodiments, will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Certain embodiments of the present disclosure provide a reconfigurable seating system and method for an internal cabin of a vehicle, such as a commercial aircraft. The seating system and method provides adaptability and increased amenities, such as within an economy class section of an internal cabin of an aircraft. In at least one embodiment, the seating system includes moveable seat assemblies proximate to a deployable table. The table is configured to be moved into a folded position, and a deployed position. The seat assemblies may be moved between different positions, such as facing a forward orientation, and facing towards the table. Embodiments of the present disclosure provide an improved travel experience focused on productivity and personal space.

Tables between seat assemblies within an internal cabin provide a versatile solution for use alongside traditional economy class, or in a specialized cabin section. Such a seating arrangement allows passengers to tailor their travel to their specific needs. In at least one embodiment, an internal cabin includes a specialized section, which includes one or more tables between seat assemblies. Airlines may offer such section at different price points than standard economy, first class, and business class tickets, for example.

In at least one embodiment, the seating system may be located within a middle, inboard area of a row of seats. As another example, the seating system may be located within an outboard area of the row.

In at least one embodiment, the seating system includes a seat assembly that is configured to move between a forward orientation and a lateral orientation. For example, the seat assembly is rotatable between the forward orientation and the lateral orientation. The forward orientation is a position in which the seat assembly faces forward towards a fore end of a vehicle. The lateral orientation is a position that faces away from the forward orientation, such as ninety degrees from the forward orientation. The seating system also includes a folding table that outwardly deploys in a lateral direction. The folding table is adjacent to either at least one other folding table or a window.

Certain embodiments of the present disclosure provide a method of reconfiguring an cabin that includes arranging a seat assembly and table in a first configuration for a first portion of a trip (such as a flight of a commercial aircraft), and arranging the seat assembly and the table in a second configuration for a second portion of the trip.

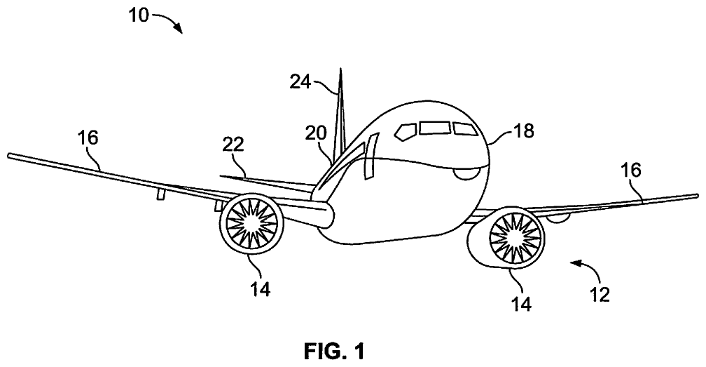

FIG. 1 illustrates a perspective top view of an aircraft 10, according to an embodiment of the present disclosure. The aircraft 10 includes a propulsion system 12 that may include two turbofan engines 14, for example. Optionally, the propulsion system 12 may include more engines 14 than shown. The engines 14 are carried by wings 16 of the aircraft 10. In other embodiments, the engines 14 may be carried by a fuselage 18 and/or an empennage 20. The empennage 20 may also support horizontal stabilizers 22 and a vertical stabilizer 24.

The fuselage 18 of the aircraft 10 defines an internal cabin, which may be defined by interior sidewall panels that connect to a ceiling and a floor. The internal cabin may include a cockpit, one or more work sections (for example, galleys, personnel carry-on baggage areas, and the like), one or more passenger sections (for example, first class, business class, and coach sections), and an aft section. Each of the sections may be separated by a cabin transition area, which may include one or more class divider assemblies. Overhead stowage bin assemblies may be positioned throughout the internal cabin.

Alternatively, instead of an aircraft, embodiments of the present disclosure may be used with various other vehicles, such as automobiles, buses, locomotives and train cars, seacraft, spacecraft, and the like.

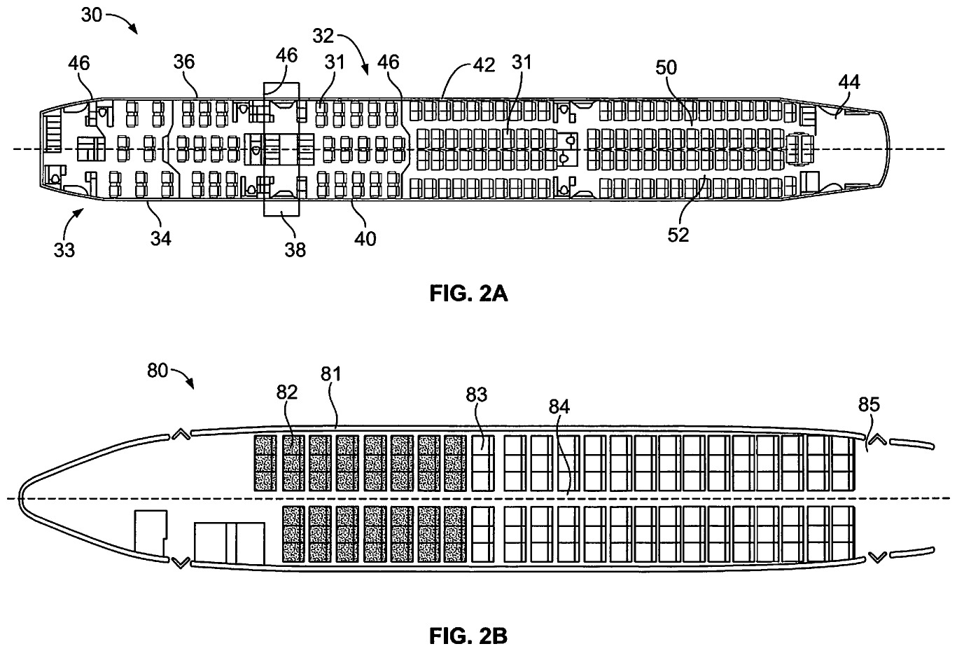

FIG. 2A illustrates a top plan view of an internal cabin 30 of an aircraft, according to an embodiment of the present disclosure. The internal cabin 30 may be within a fuselage 32 of the aircraft. For example, one or more fuselage walls may define an interior of the internal cabin 30. The interior of the internal cabin 30 is defined by sidewall panels that connect to a ceiling and a floor. The internal cabin 30 includes passenger seat assemblies 31 within multiple sections, including a front section 33, a first class section 34, a business class section 36, a front galley station 38, an expanded economy or coach section 40, a standard economy or coach section 42, and an aft section 44, which may include multiple lavatories and galley stations. It is to be understood that the internal cabin 30 may include more or less sections than shown. For example, the internal cabin 30 may not include a first class section, and may include more or less galley stations than shown. Each of the sections may be separated by a cabin transition area 46.

As shown in FIG. 2A, the internal cabin 30 includes two aisles 50 and 52 that lead to the aft section 44. Optionally, the internal cabin 30 may have less or more aisles than shown. For example, the internal cabin 30 may include a single aisle that extends through the center of the internal cabin 30 that leads to the aft section 44.

FIG. 2B illustrates a top plan view of an internal cabin 80 of an aircraft, according to an embodiment of the present disclosure. The internal cabin 80 may be within a fuselage 81 of the aircraft. For example, one or more fuselage walls may define the interior of the internal cabin 80. The internal cabin 80 includes multiple sections, including a main cabin 82 having passenger seat assemblies 83, and an aft section 85 behind the main cabin 82. It is to be understood that the internal cabin 80 may include more or less sections than shown.

The internal cabin 80 may include a single aisle 84 that leads to the aft section 85. The single aisle 84 may extend through the center of the internal cabin 80 that leads to the aft section 85. For example, the single aisle 84 may be coaxially aligned with a central longitudinal plane of the internal cabin 80.

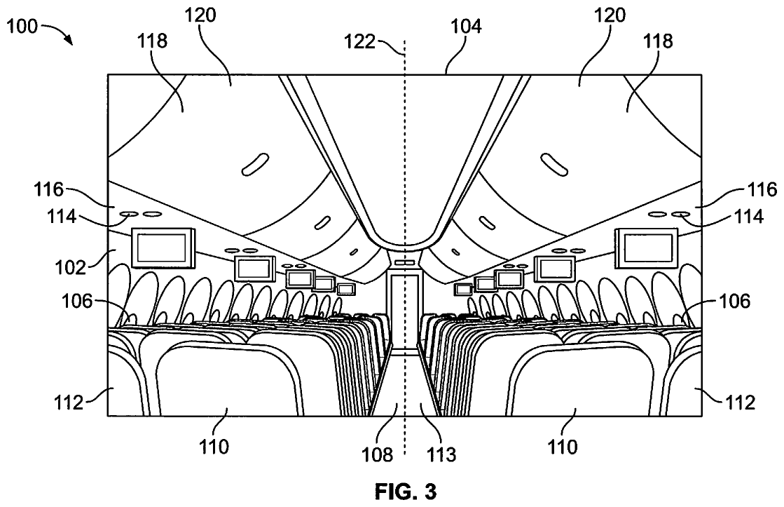

FIG. 3 illustrates a perspective interior view of an internal cabin 100 of an aircraft, according to an embodiment of the present disclosure. The internal cabin 100 includes outboard sidewalls 102 connected to a ceiling 104. Windows 106 may be formed within the outboard sidewalls 102. A floor 108 supports rows of seat assemblies 110. As shown in FIG. 3, a row 112 may include two seat assemblies 110 on either side of an aisle 113. However, the row 112 may include more or less seat assemblies 110 than shown. Additionally, the internal cabin 100 may include more aisles than shown.

Passenger service units (PSUs) 114 are secured between an outboard sidewall 102 and the ceiling 104 on either side of the aisle 113. The PSUs 114 extend between a front (fore) end and rear (aft) end of the internal cabin 100. For example, a PSU 114 may be positioned over each seat assembly 110 within a row 112. Each PSU 114 may include a housing 116 that generally contains vents, reading lights, an oxygen bag drop panel, an attendant request button, and other such controls over each seat assembly 110 (or groups of seats) within a row 112.

Overhead stowage bin assemblies 118 are secured to the ceiling 104 and/or the outboard sidewall 102 above and inboard from the PSU 114 on either side of the aisle 113. The overhead stowage bin assemblies 118 are secured over the seat assemblies 110. The overhead stowage bin assemblies 118 extend between the front and rear end of the internal cabin 100. Each stowage bin assembly 118 may include a pivot bin or bucket 120 pivotally secured to a strongback (hidden from view in FIG. 3). The overhead stowage bin assemblies 118 may be positioned above and inboard from lower surfaces of the PSUs 114. The overhead stowage bin assemblies 118 are configured to be pivoted open in order to receive passenger carry-on baggage and personal items, for example.

As used herein, the term “outboard” means a position that is further away from a central longitudinal plane 122 of the internal cabin 100 as compared to another component. The term “inboard” means a position that is closer to the central longitudinal plane 122 of the internal cabin 100 as compared to another component. For example, a lower surface of a PSU 114 may be outboard in relation to a stowage bin assembly 118.

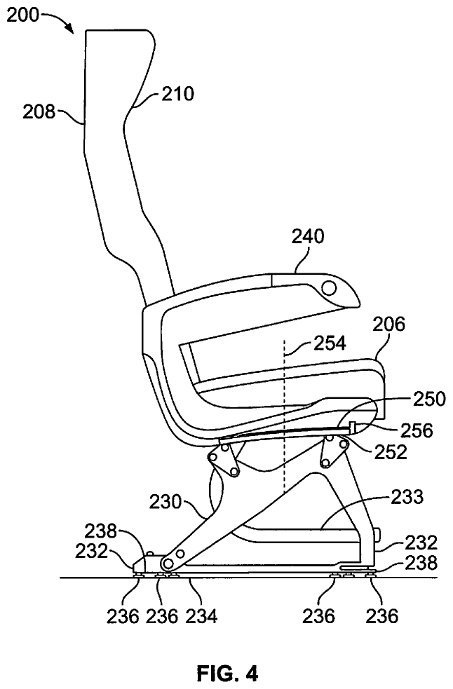

FIG. 4 illustrates a side view of a seat assembly 200, according to an embodiment of the present disclosure. The seat assembly 200 is an example of the seat assemblies 31 (shown in FIG. 2A), 83 (shown in FIG. 2B), and 110 (shown in FIG. 3). The seat assembly 200 is configured to be secured within an internal cabin of a vehicle, such as a commercial aircraft.

The seat assembly 200 includes a base 230, which may include legs 232 that may be secured to seat tracks 234 within an internal cabin of a vehicle. The legs 232 on a same side of the seat assembly 200 may be connected together by a spanner bar 233. In at least one embodiment, securing studs 236 (such as shear studs) downwardly extend from lower surfaces 238 of the legs 232. The securing studs 236 are securely retained within the seat tracks 234. The seat tracks 234 are configured to securely couple to the securing studs 236 to secure the seat assembly 200 in place. The base 230 supports a seat cushion 206 and a backrest 208, which includes a headrest 210. Arm rests 240 may be pivotally secured to the backrest 208.

In at least one embodiment, the base 230 of the seat assembly 200 also includes a rotor 250 that is rotatably coupled to a fixed mount 252. For example, the rotor 250 and the fixed support mount 252 may be disposed above the legs 232, such as below or within the seat cushion 206. The rotor 250 allows the seat assembly 200, such as the seat cushion 206 and the backrest 208, to rotate about an axis 254. As such, the seat assembly 200 is configured to be moved, such as via rotation, between different positions. The seat assembly 200 may also include a lock 256 that is configured to lock the seat assembly in a desired position. For example, the lock 256 may be engaged to secure the rotor 250 relative to the support mount 252. Optionally, the seat assembly 200 may be configured to rotate at locations other than shown. For example, the seat assembly may include a column that secures to seat tracks. The column may include a rotor and a support mount.

The seat assembly 200 may be sized and shaped differently than shown in FIG. 4. The seat assembly 200 may include more or less components than shown in FIG. 4. It is to be understood that the seat assembly 200 shown in FIG. 4 is merely one example of a seat assembly that may be disposed within an internal cabin of a vehicle.

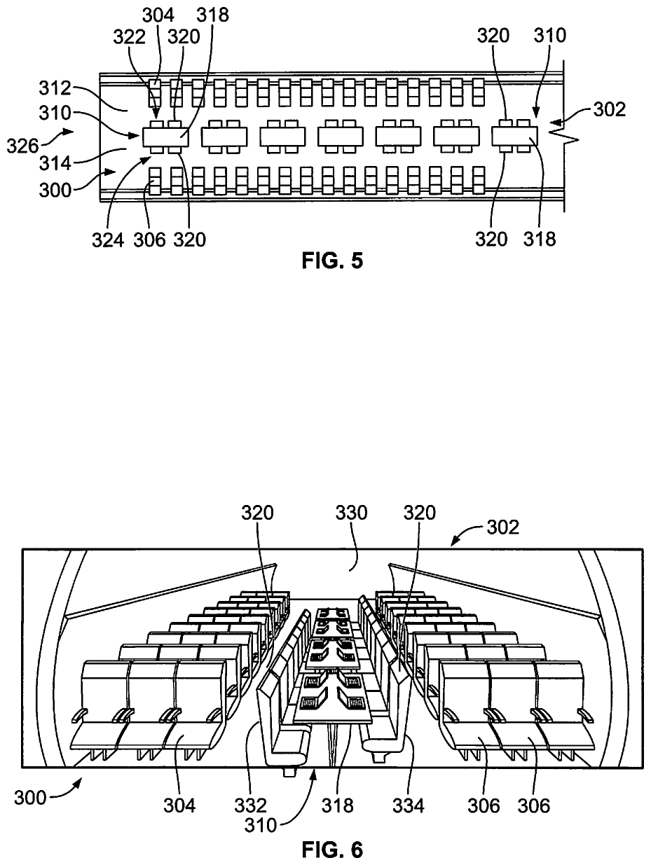

FIG. 5 illustrates a top plan view of a section 300 within an internal cabin 302 of an aircraft, according to an embodiment of the present disclosure. The section 300 may replace one or more portions of the sections shown in FIGS. 2A and 2B, for example.

The section 300 includes outboard seat assemblies 304 (for example, first outboard seat assemblies 304 on one side), outboard seat assemblies 306 (for example, second outboard seat assemblies 306 on an opposite side), and seating systems 310 between the outboard seat assemblies 304 and the outboard seat assemblies 306. The seating systems 310 may replace middle seat assemblies between aisles 312 and 314.

The seating systems 310 include a table 318 between seat assemblies 320. As shown, each seating system 310 may include a table 318, which may be centrally located, between a first pair 322 of seat assemblies 320 and a second pair 324 of seat assemblies 320. As an example, the first pair 322 of seat assemblies 320 are proximate to (for example, coupled to, or spaced within 3 feet or less of) a first side of the table 318 and the second pair 324 of seat assemblies 320 are proximate to a second side (opposite from the first side) of the table 318.

The outboard seat assemblies 304 and the outboard seat assemblies 306 are forwardly-oriented, such that they face in a forward direction towards a fore area or end 326 of the aircraft. The seat assemblies 320 are laterally-oriented, such that they face in a lateral direction (for example, ninety radial degrees from the forward direction). The seat assemblies 320 of the first pair 322 face the seat assemblies 320 of the second pair 324.

As shown, a plurality of seating systems 310 are disposed within the section 300. The seating systems 310 may include more or less seat assemblies 320 than shown. For example, the seating system 310 may include one seat assembly 320 proximate to (for example, adjacent) a table 318. In at least one embodiment, a single table may extend along an entire or substantial length of the section 300. For example, instead of multiple separate tables 318, a single long table 318 may extend between the seat assemblies 320 on one side and the seat assemblies 320 on an opposite side.

In at least one embodiment, the seat assemblies 320 are configured to be move between the forward orientation (facing forward) and the lateral orientation (facing laterally). Alternatively, the seat assemblies 320 may be fixed in position. In at least one embodiment, the tables 318 are configured to be moved between an upright folded stowed position, and an outwardly deployed flat position. Alternatively, the tables 318 may be fixed in position.

FIG. 6 illustrates a perspective view of the section 300 within the internal cabin 302 of the aircraft. The view shown in FIG. 6 is towards an aft area 330 of the internal cabin 302. Three outboard seat assemblies 304 are positioned to one side 332 of the seating system 310 and three outboard seat assemblies 306 are positioned to an opposite side 334 of the seating system 310.

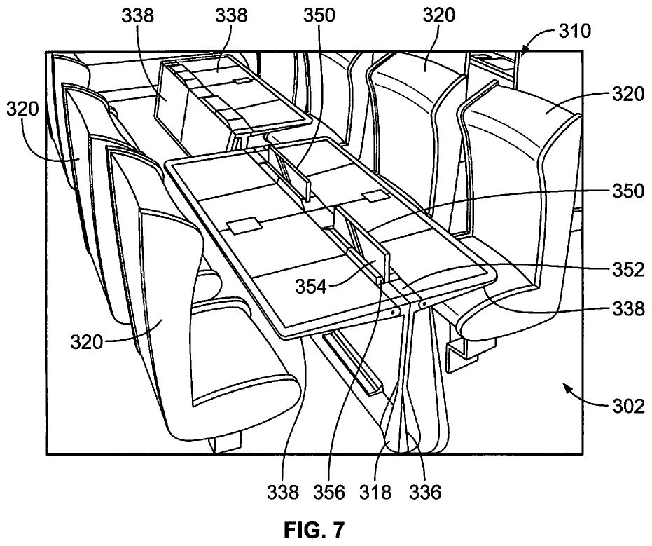

FIG. 7 illustrates a perspective top view of seating systems 310 within the internal cabin 302, according to an embodiment of the present disclosure. The table 318 includes a central support member 336 (such a column(s), wall(s), leg(s), beam(s), and/or the like) and panels 338 coupled to the central support member 336. The central support member 336 is secured to a floor of the internal cabin. In at least one embodiment, the central support member 336 is secured to one or more seat tracks on and/or in the floor of the internal cabin. In at least one embodiment, the panels 338 are moveably coupled to the central support member 336. For example, the panels 338 may be pivotally coupled to the central support member 336. Locks may be used to secure the panels 338 in desired positions relative to the central support member 336.

The panels 338 are configured to be outwardly and laterally deployed, such as in horizontal positions, to provide a work surface. The panels 338 are also configured to be folded into retracted, stowed positions, such as vertically-oriented positions.

In at least one embodiment, the table 318 also includes one or more user interfaces 350 extending upwardly from a top surface 352 of the central support member 336. Each user interface 350 may include a display 354, such as a television or electronic monitor/screen, touchpad, or the like. The user interfaces 350 may include one or more lights, such as to provide illumination for reading. The user interfaces 350 may include touchscreen interfaces, keyboards, or the like. The user interfaces 350 may also include a device charger 356, such as below the display 354 and/or at an end. The device charger 356 includes an outlet. A device, such as a smart phone, tablet, or the like, may be plugged into the device charger 356 so that the device may be recharged. The seating system 310 may include more or less user interfaces 350 than shown. For example, the seating system 310 may include three or more user interfaces 350, or no user interfaces 350.

The seating system 310 includes the table 318 having at least one panel 338 that is configured to be moved between a stowed position and a deployed position, and at least one seat assembly 320 proximate to the table 318. For example, the seat assembly 320 is adjacent to the table 318. The seat assembly 320 may be directly connected to the table 318. Optionally, the seat assembly 320 may be separated from the table 318, such as within one or two feet of the table 318. The seat assembly 320 is configured to be moved between a forward orientation in which the seat assembly faces away from the table 318 (such as towards a fore area of the internal cabin 302), and a lateral orientation in which the seat assembly faces towards the table 318 (for example, a passenger seated within the seating assembly 320 faces the table 318).

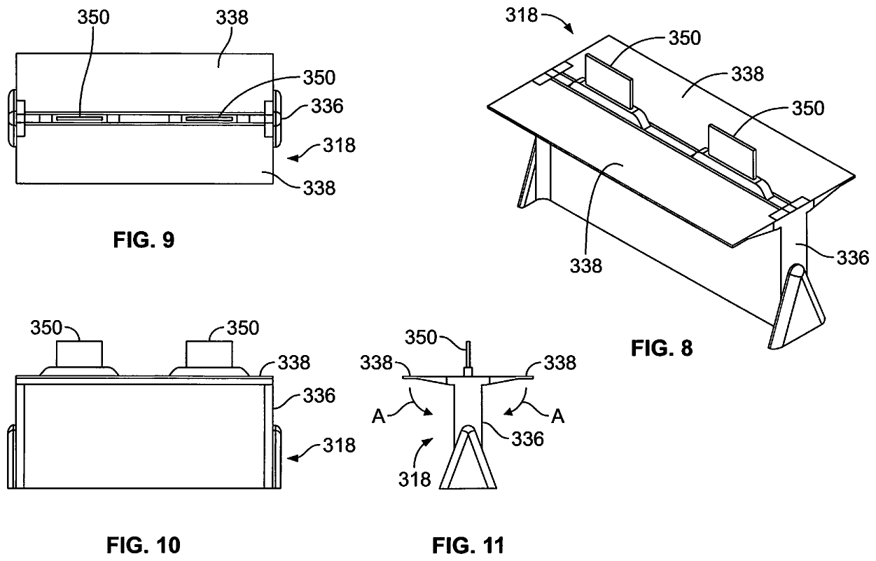

FIG. 8 illustrates a perspective top view of the table 318 having the panels 338 in deployed positions, according to an embodiment of the present disclosure FIG. 9 illustrates a top view of the table 318 having the panels 338 in deployed positions. FIG. 10 illustrates a lateral view of the table 318 having the panels 338 in deployed positions. FIG. 11 illustrates an end view of the table 318 having the panels 338 in deployed positions.

Referring to FIGS. 8-11, the panels 338 extend laterally outward in the deployed positions. For example, in the deployed positions, the panels 338 are laterally extended to provide a flat, level surface that may be parallel to a floor of an internal cabin. Optionally, the table 318 may include only one panel 338 that is moveably coupled to the central support member 336.

In order to move the panels 338 into stowed positions, the panels 338 are downwardly pivoted in the direction of arrows A. The panels 338 may be locked in desired positions, such as via locks.

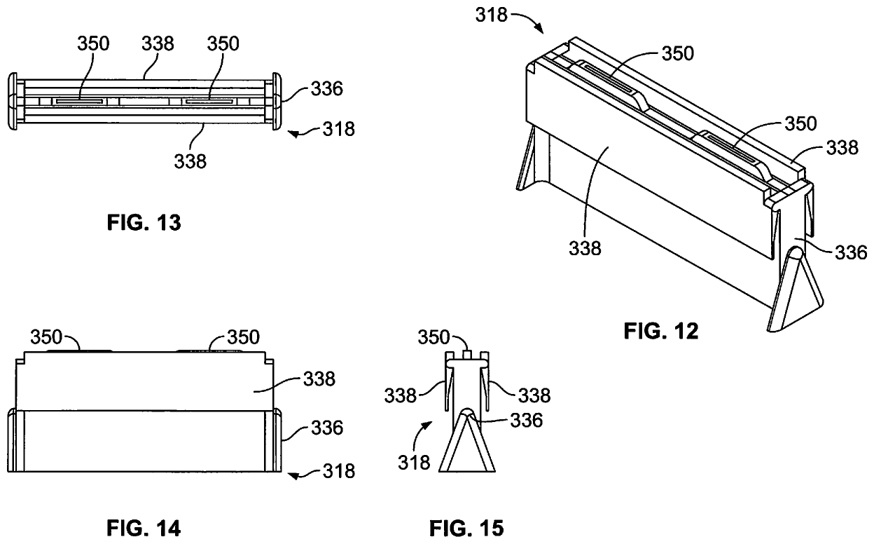

FIG. 12 illustrates a perspective top view of the table 318 having the panels 338 in stowed positions. FIG. 13 illustrates a top view of the table 318 having the panels 338 in stowed positions. FIG. 14 illustrates a lateral view of the table 318 having the panels 338 in stowed positions. FIG. 15 illustrates an end view of the table 318 having the panels 338 in stowed positions.

Referring to FIGS. 12-15, in the stowed positions, the panels 338 may be downwardly pivoted to be folded towards the central support wall 336. The panels 338 in the stowed positions may be rotated ninety radial degrees from the deployed positions.

In at least one embodiment, displays of the user interfaces 350 may be configured to downwardly recede towards and/or into the central support member 336. The displays may downwardly recede (such as shown in FIGS. 12-15) during certain phases of a flight, such as during takeoff and landing, when use of electronic devices may be restricted.

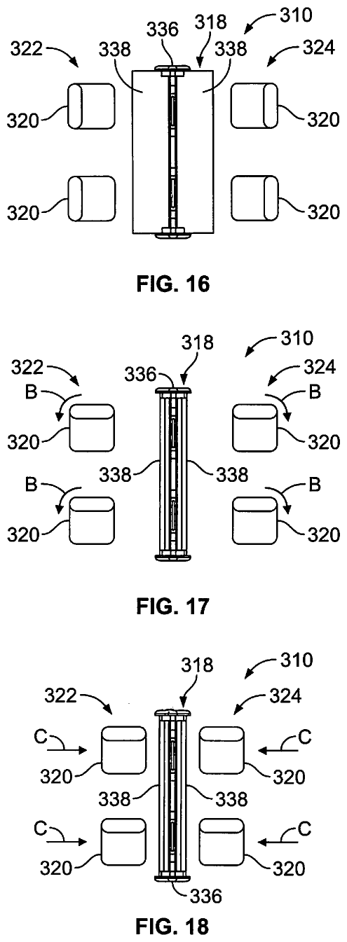

FIG. 16 illustrates a top view of the seating system 310 in a first configuration, according to an embodiment of the present disclosure. The first configuration may be used during a portion of a flight, such when the aircraft is at a cruising altitude and speed. The first configuration is a working configuration in which the panels 338 are in deployed positions to provide work space for individuals. In the first configuration, the seat assemblies 320 of the first pair 322 face the seat assemblies 320 of the second pair 324. As such, the seat assemblies 320 are oriented towards (that is, face) the table 318 so as to face in lateral directions (in contrast to a forward direction).

FIG. 17 illustrates a top view of the seating system 310 in a second configuration, according to an embodiment of the present disclosure. During certain phases of a flight, the seating system 310 is moved into the second configuration. For example, during take-off and landing, the seating system 310 is in the second configuration. It is to be understood that the terms first, second, and third, for example, are merely for labeling. The first configuration may be the second configuration, and vice versa, for example.

In the second configuration, the panels 338 are moved into the stowed positions. Further, the seat assemblies 320 are rotated in the direction of arcs B into forward orientations.

In order to move the seating system 310 back to the first configuration, the process is reversed. That is, the seat assemblies 320 are rotated to face lateral directions, and the panels 338 are pivoted into deployed positions.

FIG. 18 illustrates a top view of the seating system 310 in a third configuration, according to an embodiment of the present disclosure. In the third configuration, the seat assemblies 320 may be shifted towards the table 318 in the directions of arrows C. Optionally, the seating system 310 may not be moved into the third configuration. For example, the seat assemblies 320 may not be configured to be shifted towards and away from the table.

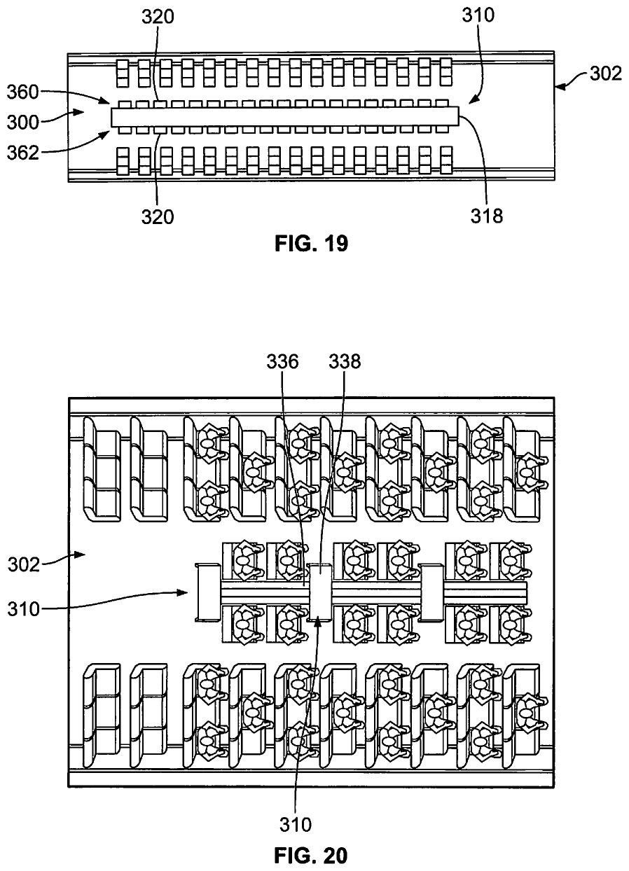

FIG. 19 illustrates a top plan view of a section 300 within an internal cabin 302 of an aircraft, according to an embodiment of the present disclosure. The section 300 is similar to the section 300 shown in FIG. 5, except that a single table 318 is positioned between a first column 360 of seat assemblies 320 and a second column 362 of seat assemblies 320. In this embodiment, the seating system 310 includes the central, single table 318 and the first column 360 of the seat assemblies 320 and the second column 362 o the seat assemblies 320. The seat assemblies 320 may be configured to move, as described herein. Further, the table 318 may include one or more panels that are configured to move between a deployed position and a stowed position, as described herein. The seating system 310 shown in FIG. 19 may include more or less seat assemblies 320 than shown.

FIG. 20 illustrates a top view of seating systems 310 within an internal cabin 302, according to an embodiment of the present disclosure. In this embodiment, the panels 338 of the tables 318 may not extend along an entire length of the central support member 336. Instead, the panels 338 may extend along a front portion (such as front half or quarter) of the central support member 336. The panels 338 may be moved between deployed and stowed positions, as described herein.

FIG. 21 illustrates a perspective view of a seating system 310 within an internal cabin 302, according to an embodiment of the present disclosure. In this embodiment, the panels 338 of the table 318 are configured to upwardly pivot into a folded, stowed position.

FIG. 22 illustrates a perspective view of a seating system 310 within an internal cabin 302, according to an embodiment of the present disclosure. In this embodiment, instead of a central support member connected to a floor 372, the table 318 may includes a central beam 370 that connects to a ceiling, thereby suspending the table 318 above the floor.

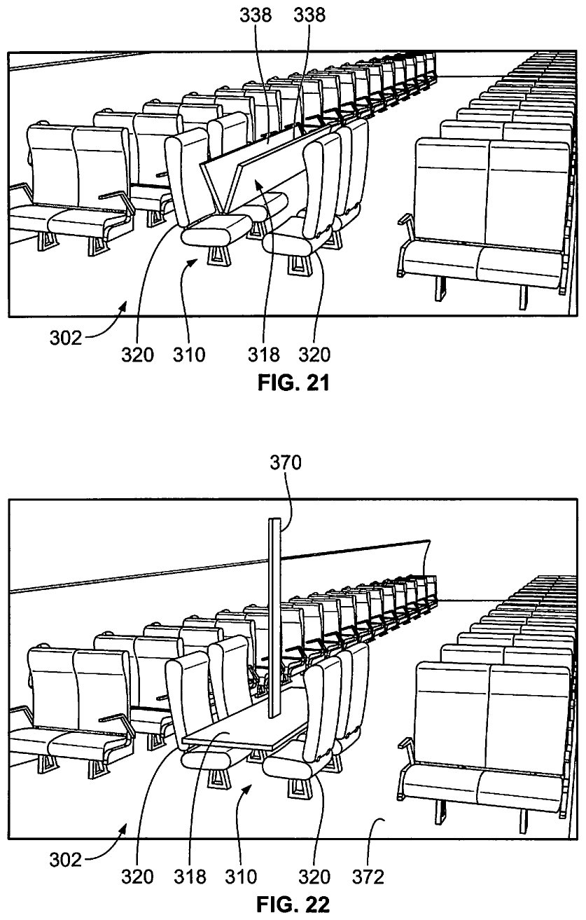

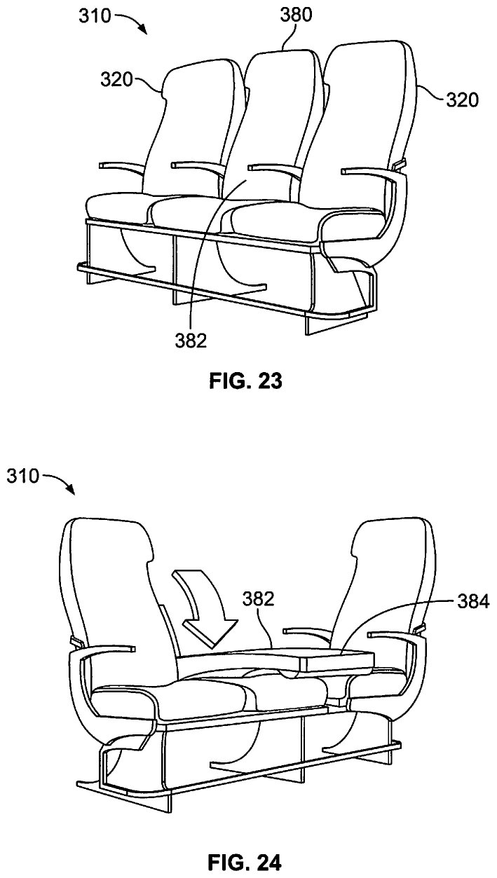

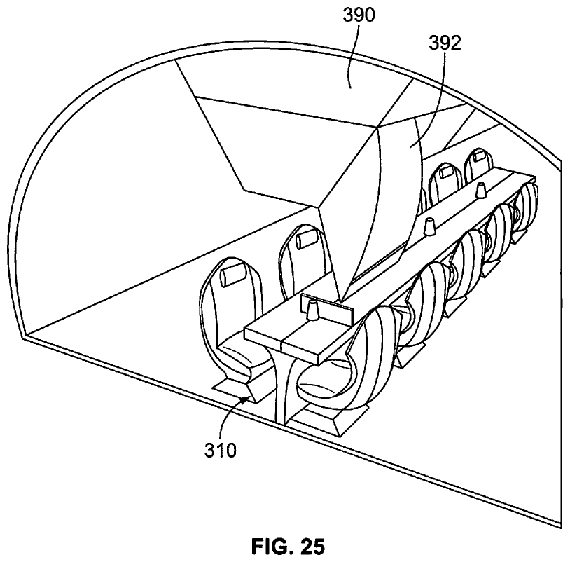

FIG. 23 illustrates a perspective front view of a seating system 310 in a first configuration, according to an embodiment of the present disclosure. FIG. 24 illustrates a perspective front view of the seating system 310 in a second configuration, according to an embodiment of the present disclosure. Referring to FIGS. 23 and 24, the seating system 310 includes the seat assemblies 320 and a central adaptable seat table assembly 380 between the seat assemblies 320. The seat table assembly 380 includes a backrest 382 that is configured to be moved between an upright position to provide a passenger seat, as shown in FIG. 23, and a downwardly-folded position to provide a table 384, as shown in FIG. 23. Thus, the backrest 382 in the upright position provides the table 384 in the stowed position, while the backrest in the downwardly-folded position provides the table 384 in the deployed position. The seat assemblies 320 may be configured to be moved between forward orientations (for example, facing towards forward directions), as shown in FIG. 23, and lateral orientations (for example, facing towards lateral directions), such as described herein.

FIG. 25 illustrates a perspective view of a seating system 310 within an internal cabin 302, according to an embodiment of the present disclosure. As shown, the seating system 310 may be located along a central plane of the internal cabin 302 underneath a stowage bin assembly 390 having a plurality of pivotal bins 392. Optionally, the seating system 310 may be located towards a side of the internal cabin 302, such as along a sidewall having windows.

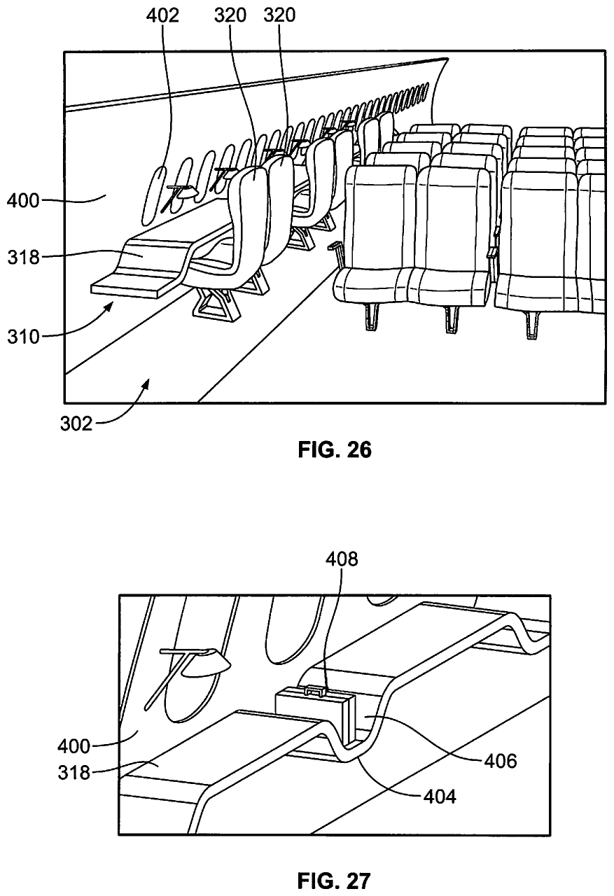

FIG. 26 illustrates a perspective view of a seating system 310 within an internal cabin 302, according to an embodiment of the present disclosure. In this embodiment, the seating system 310 is along a sidewall 400 of the internal cabin 302. The sidewall 400 has a plurality of windows 402. The table 318 may extend from the sidewall 400. The table 318 may be fixed in position, or may be configured to move between a deployed position and a stowed position. The seat assembly 320 may be configured to be moved between different orientations.

FIG. 27 illustrates a perspective view of the table 318 of the seating system 310, according to an embodiment of the present disclosure. In at least one embodiment, the table 318 may include a pocket 404 defining a storage chamber 406. Items 408 (such as carry-on luggage, reading material, and the like) may be stored in the storage chamber 406. The tables 318 of any of the embodiments described herein may include a storage chamber 406, whether formed on a top surface, a lateral surface (such as on the central support member 336, shown in FIG. 7, for example), or the like.

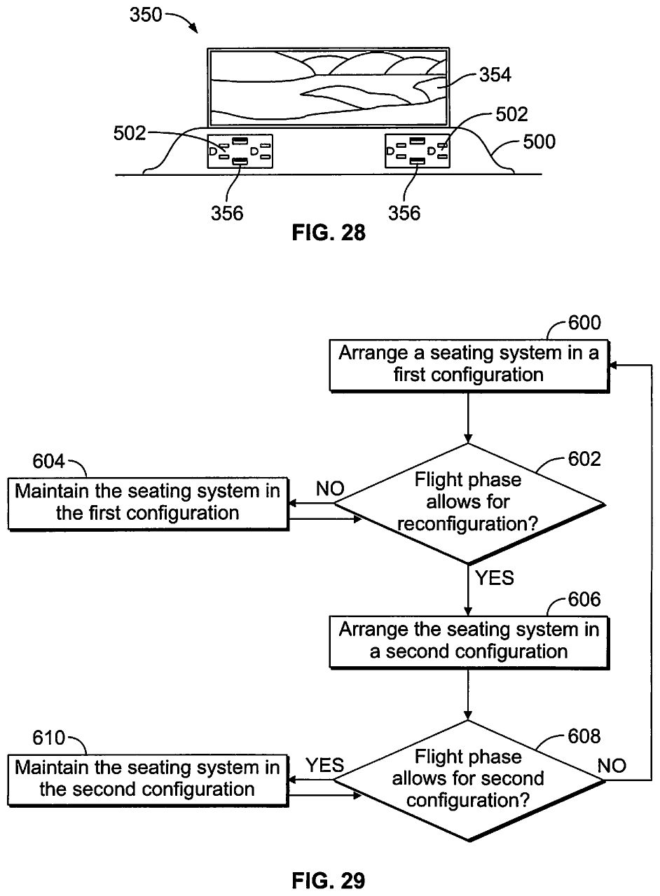

FIG. 28 illustrates a front view of a user interface, according to an embodiment of the present disclosure. As noted, the user interface 350 extends upwardly from a top surface 352 of the central support member 336 (as shown in FIG. 7). The user interface 350 includes a housing 500 and the display 354. The display 354 may be configured to selectively extend upwardly from and recede into the housing 500. The device chargers 356 have outlets 502 on the housing 500. A device may be plugged into the outlets 502.

FIG. 29 illustrates a flow chart of a seating method within an internal cabin of an aircraft, according to an embodiment of the present disclosure. At 600, a seating system is arranged in a first configuration. For example, the table 318 (shown in FIG. 7) and the seat assemblies 320 (shown in FIG. 7) are arranged in the first configuration. In the first configuration, the panels 338 of the table 318 are in stowed positions, and the seat assemblies 320 are in a forward orientation, in which they face towards a fore area of the aircraft away from the table 318.

At 602, it is determined if a flight phase allows for reconfiguration. For example, during take-off and landing, reconfiguration may not be allowed. However, during a cruising phase of a flight, reconfiguration may be allowed. If the flight phase does not allow for reconfiguration, the method proceeds to 604, at which the seating system is maintained in the first configuration. The method then returns to 602.

If, however, the flight phase does allow for reconfiguration, the method proceeds from 602 to 606, at which the seating system is reconfigured or otherwise arranged into a second configuration. For example, the table 318 and the seat assemblies 320 are arranged in the second configuration. In the second configuration, the panels 338 of the table are in deployed positions, and the seat assemblies 320 are in lateral orientations, in which they face the table 318. Notably, the configuration of the seating system may be changed during different phases of the same flight.

At 608, it is determined if the current or upcoming flight phase allows for the second configuration. If so, the method proceeds to 610, at which the seating system is maintained in the second configuration. If not, the method returns to 600 from 608.

As described herein, embodiments of the present disclosure provide a reconfigurable seating system and method within an internal cabin of a vehicle. Further, embodiments of the present disclosure provide a seating system and method within an internal cabin that provides increased work space, amenities, and adaptability for passengers.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A seating system for an internal cabin of an aircraft, the seating system comprising:
a table having at least one panel that is configured to be moved between a stowed position and a deployed position; and
at least one seat assembly proximate to the table, wherein the at least one seat assembly is configured to be moved between a forward orientation in which the at least one seat assembly faces away from the table, and a lateral orientation in which the at least one seat assembly faces towards the table.

2. The seating system of claim 1, wherein the at least one seat assembly is configured to be secured to seat tracks within the internal cabin.

3. The seating system of claim 1, wherein the at least one seat assembly comprises a first pair of seat assemblies proximate to a first side of the table and a second pair of seat assemblies proximate to a second side of the table, wherein the second side is opposite from the first side.

4. The seating system of claim 1, wherein the table comprises a central support member, wherein the at least one panel is moveably coupled to the central support member.

5. The seating system of claim 4, wherein the at least one panel comprises two panels moveably coupled to the central support member.

6. The seating system of claim 4, wherein the at least one panel is configured to be outwardly and laterally deployed to provide a work surface.

7. The seating system of claim 4, wherein the at least one panel extends along an entire length of the central support member.

8. The seating system of claim 4, wherein the at least one panel extends along a front portion of the central support member.

9. The seating system of claim 1, wherein the table comprises at least one user interface extending upwardly from a top surface.

10. The seating system of claim 1, wherein the at least one user interface comprises a display.

11. The seating system of claim 1, wherein the at least one user interface comprises a device charger.

12. The seating system of claim 1, wherein the at least one seat assembly comprises a first column of a plurality of seat assemblies and a second column of a plurality of seat assemblies, and wherein the table is between the first column and the second column.

13. The seating system of claim 1, further comprising a central adaptable seat table assembly coupled to the at least one seat assembly, wherein the central adaptable seat assembly includes the table.

14. The seating system of claim 13, wherein the central adaptable seat table assembly comprises a backrest, wherein the backrest is configured to be moved between an upright position providing the table in the stowed position, and a downwardly-folded position providing the table in the deployed position.

15. The seating system of claim 1, wherein the seating system is configured to be disposed along a central plane of the internal cabin underneath a stowage bin assembly.

16. The seating system of claim 1, wherein the seating system is configured to be disposed along a sidewall of the internal cabin.

17. The seating system of claim 16, wherein the table is configured to extend from the sidewall.

18. The seating system of claim 1, wherein the table comprises a pocket defining a storage chamber.

19. A seating method for an internal cabin of an aircraft, the seating method comprising:
arranging a table and at least one seat assembly of a seating system within the internal cabin of the aircraft in a first configuration during a first phase of a flight of the aircraft; and
reconfiguring the table and the at least one seat assembly of the seating system within the internal cabin of the aircraft into a second configuration during a second phase of the flight of the aircraft.

20. The seating method of claim 19, wherein said arranging comprises:
moving at least one panel of a table into a stowed position; and
moving the at least one seat assembly into a forward orientation in which the at least one seat assembly faces away from the table.

21. The seating method of claim 20, wherein said reconfiguring comprises:
moving the at least one panel of the table into a deployed position; and
moving the at least one seat assembly into a lateral orientation in which the at least one seat assembly faces towards the tables.

22. The seating method of claim 19, further comprising securing the at least one seat assembly to seat tracks within the internal cabin.

23. The seating method of claim 19, wherein said reconfiguring comprises outwardly and laterally deploying the at least one panel to provide a work surface.

24. The seating method of claim 19, further comprising providing the table with at least one user interface having a display.

25. The seating method of claim 24, further comprising providing the at least one user interface with a device charger.

26. The seating method of claim 19, further comprising coupling a central adaptable seat table assembly to the at least one seat assembly, wherein the central adaptable seat assembly includes the table.

27. The seating method of claim 26, further comprising moving a backrest of the adaptable seat table assembly between an upright position providing the table in the stowed position, and a downwardly-folded position providing the table in the deployed position.

28. The seating method of claim 19, further comprising disposing the seating system along a central plane of the internal cabin underneath a stowage bin assembly.

29. The seating method of claim 19, further comprising disposing the seating system along a sidewall of the internal cabin.

30. The seating method of claim 29, wherein said disposing comprises extending the table from the sidewall.

31. An aircraft comprising:
an internal cabin; and
a seating system within the internal cabin, wherein the seating system comprises:
a table having at least one panel that is configured to be moved between a stowed position and a deployed position; and
at least one seat assembly proximate to the table, wherein the at least one seat assembly is configured to be moved between a forward orientation in which the at least one seat assembly faces away from the table, and a lateral orientation in which the at least one seat assembly faces towards the table.

32. The aircraft of claim 31, wherein the at least one seat assembly is secured to seat tracks within the internal cabin.

33. The aircraft of claim 31, wherein the at least one seat assembly comprises a first pair of seat assemblies proximate to a first side of the table and a second pair of seat assemblies proximate to a second side of the table, wherein the second side is opposite from the first side.

34. The aircraft of claim 31, wherein the table comprises a central support member, wherein the at least one panel is moveably coupled to the central support member.

35. The aircraft of claim 34, wherein the at least one panel comprises two panels moveably coupled to the central support member.

36. The aircraft of claim 34, wherein the at least one panel is configured to be outwardly and laterally deployed to provide a work surface.

37. The aircraft of claim 34, wherein the at least one panel extends along an entire length of the central support member.

38. The aircraft of claim 31, wherein the table comprises at least one user interface extending upwardly from a top surface, wherein the at least one user interface comprises a display and a device charger.

39. The aircraft of claim 31, wherein the at least one seat assembly comprises a first column of a plurality of seat assemblies and a second column of a plurality of seat assemblies, and wherein the table is between the first column and the second column.

40. The aircraft of claim 31, wherein the seating system further comprises a central adaptable seat table assembly coupled to the at least one seat assembly, wherein the central adaptable seat assembly includes the table.

41. The aircraft of claim 40, wherein the central adaptable seat table assembly comprises a backrest, wherein the backrest is configured to be moved between an upright position providing the table in the stowed position, and a downwardly-folded position providing the table in the deployed position.

42. The aircraft of claim 31, wherein the seating system is be disposed along a central plane of the internal cabin underneath a stowage bin assembly.

43. The aircraft of claim 31, wherein the seating system is disposed along a sidewall of the internal cabin.

44. The aircraft of claim 43, wherein the table extends from the sidewall.

45. The aircraft of claim 31, wherein the table comprises a pocket defining a storage chamber.
